(19) United States
(12) Patent Application Publication
(10) Pub. No.: US 2026/0099293 A1
(43) Pub. Date: Apr. 9, 2026

(54) SIDEBAND AUDIO OFFLOAD

(71) Applicant: Advanced Micro Devices, Inc., Santa Clara, CA (US)

(72) Inventors: Virendra Pratap Arya, Hyderabad (IN); UmaSankara Rao Balla, Hyderabad (IN); Bhupal Lella, Hyderabad (IN); Naga Malleswarao Kandimalla, Hyderabad (IN)

(73) Assignee: Advanced Micro Devices, Inc., Santa Clara, CA (US)

(21) Appl. No.: 18/909,594

(22) Filed: Oct. 8, 2024

(51) Int. Cl. G06F 3/16

(52) U.S. Cl. CPC G06F 3/162

(57) ABSTRACT

Output of audio data from a computing device to an output device can be a complex operation. To alleviate the burden of frequent generation of audio data on the application, some systems provide an “offload mode” of operation, in which the application writes a large chunk of data into a buffer in memory and the audio hardware processes this data and sends the processed data to an output device. In some examples, in this offload mode, the data transmitted from the audio hardware to the audio device is transmitted via a buffer in system memory. An issue with this configuration, however, is that system memory is frequently accessed. To counteract this effect, a buffer is provided within the audio hardware. This buffer holds the processed audio data to be read by the interconnect controller, relieving pressure on system memory.

### BACKGROUND

Output of audio data to an output device (e.g., a speaker or headphones) can involve a number of different device components such as a digital signal processor, interconnect controller, and others. The configuration of such components and the specifics of the operations involved in such output can have a large effect on the power efficiency of such operations.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates an audio offload mode for providing audio data to the audio device for playback, according to an example;

FIG. 3 illustrates a system including an audio digital signal processor that includes an output buffer and an event buffer, both of which are not part of the system memory;

FIG. 4 is a block diagram of a system according to another example;

FIG. 5 is a block diagram of an example implementation of the audio digital signal processor of FIGS. 3 and 4, according to an example; and

FIG. 6 is a flow diagram of a method for outputting audio, according to an example.

### DETAILED DESCRIPTION

Output of audio data from a computing device to an output device can be a relatively complex operation. In an example, such output ultimately transmits audio data to an output device connected to the device via an interconnect such as universal serial bus (“USB”). An application or other software or hardware must generate audio data for output to the output device. To alleviate the burden of frequent generation of audio data on the application, systems provide an “offload mode” of operation, in which the application writes a large chunk of data into a buffer in memory and the audio hardware (e.g., audio digital signal processor (“DSP”)) and interconnect hardware (e.g., USB controller) processes this data and ultimately sends the processed data to an output device.

In some examples, in this offload mode, an audio driver allocates several buffers in system memory—one for an application to “offload” audio data into, and another for the audio DSP to output data into to be read by the interconnect controller (e.g., USB controller) and ultimately output to the audio device. An issue with this configuration, however, is that system memory is frequently accessed, meaning that power conservation features that rely on powering the system memory down when unused cannot be employed or are hindered.

To counteract this effect, a buffer is provided within the audio DSP itself. This buffer holds the processed audio data output by the audio DSP to be read by the interconnect controller. For initialization, the audio driver allocates this buffer in the audio DSP and then informs the interconnect controller of its location (e.g., address). The buffer can be accessed using an input/output memory management unit (“IOMMU”) for address translation, resulting in the interconnect controller being able to directly read from the buffer in the audio DSP. This alleviates the pressure on system memory and allows system memory to be powered down while otherwise unused.

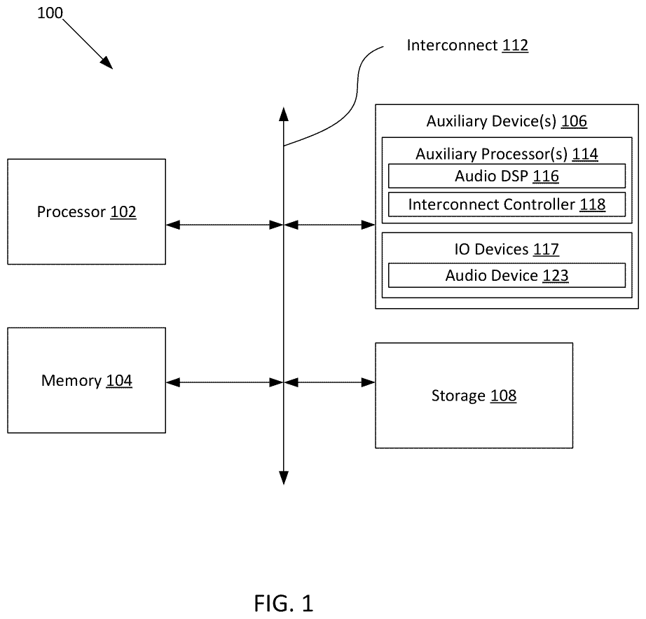

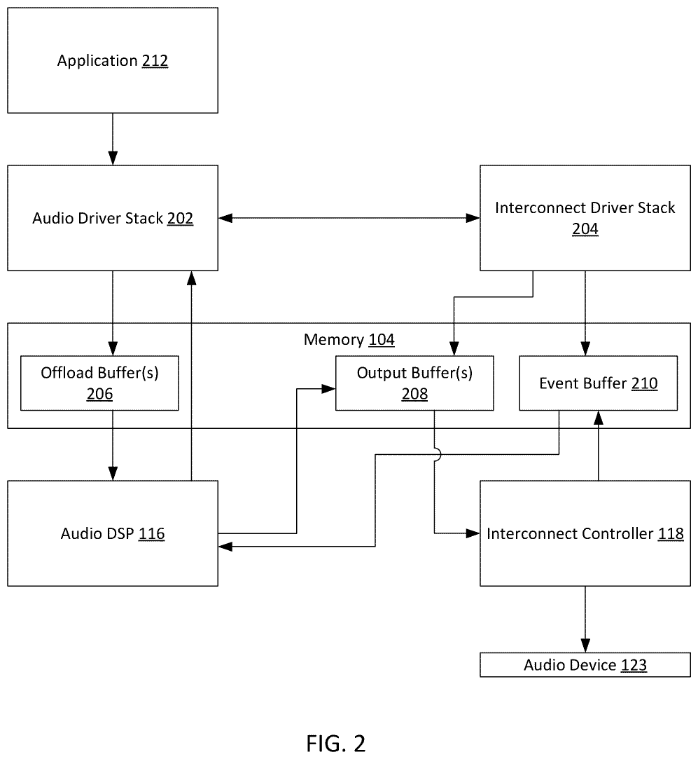

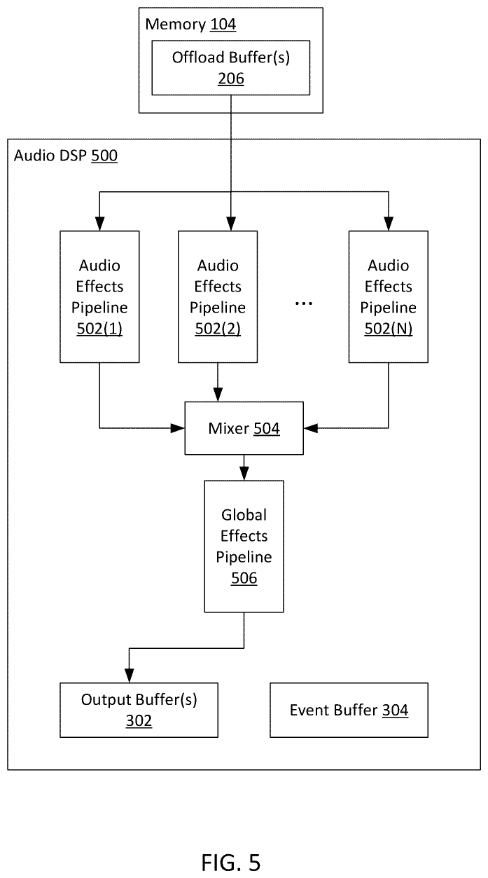

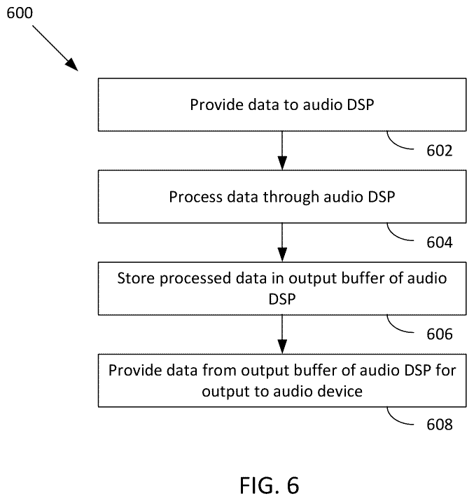

FIG. 1 illustrates a device in which techniques of the present disclosure are implemented. FIGS. 2-4 represent audio hardware configurations. FIG. 5 illustrates example details of an audio DSP. FIG. 6 illustrates a method for processing audio data.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

The IO devices 117 includes an audio device 123. The audio device is configured to produce sound in the environment to be heard by a user. The auxiliary processors include an audio digital signal processor (“audio DSP”) 116 and an interconnect controller 118. In some examples, the audio DSP includes a set of circuitry that performs operations to retrieve sound data from software (e.g., an application executing on the processor 102) or another entity, to process that data (where such processing includes, for example, resampling (e.g., converting the sample rate from that of the input audio data to a sample rate), mixing multiple audio signals (e.g., combining two different signals), applying audio effects to individual signals (e.g., equalization adjustments, or other audio effects), applying audio effects to the final mixed signals, and other processor), and to provide the audio data to the audio devices 123 to be played and heard, via the interconnect controller 118. The interconnect controller 118 is also a processor (including, e.g., circuitry configured to perform the operations described herein, in some examples including instructions as software or firmware). The interconnect controller 118 provides audio data from the audio DSP 116 to the audio device 123. In an example, the interconnect controller 118 is a universal serial bus (“USB”) controller, the interconnect 112 includes a USB bus, and the audio device 123 is coupled to that USB bus. Thus, in these examples, the interconnect controller 118 directs audio data to the audio device 123 via the USB bus.

In some examples, an application directly provides audio data to the audio device 123 via the interconnect controller 118 and an interconnect driver (e.g., a USB driver). In such examples, the interconnect controller 118 periodically requests new audio data to provide to the audio device 123. If this is serviced directly by the application, this is quite burdensome, so an “audio offload” mode is provided.

FIG. 2 illustrates the audio offload mode for providing audio data to the audio device 123 for playback, according to an example. In FIG. 2, an application 212 (executing on, e.g., the processor 102) initializes an interaction with the audio driver stack 202. In addition, the audio driver stack 202 requests the interconnect driver stack 204 to allocate the output buffer 208 and event buffer 210 in the memory 104. The interconnect driver stack 204 does this and provides the address of the output buffer 208 and event buffer 210 in memory to the audio driver stack 202. The audio driver stack 202 also allocates an offload buffer 206 in memory. In addition, the audio driver stack 202 instructs the audio DSP 116 as to the location in memory 104 of the offload buffer 206, the output buffer 208, and the event buffer 210. To output audio to the audio device 123, the application 212 writes audio data into the offload buffer 206 via the audio driver stack 202. The audio driver stack 202 instructs the audio DSP 116 to process this audio data (e.g., as described elsewhere herein) and to write the resulting processed data into the output buffer 208 for use by the interconnect controller 118.

The audio DSP 116 continuously reads data from the offload buffer 206, processes that data, and provides the processed data to the output buffer 208. In some examples, when the interconnect controller 118 needs additional audio data to provide to the audio device 123 (e.g., due to the output buffer 208 not having enough data), the interconnect controller 118 writes an audio data request event into the event buffer 210. The audio DSP 116 reads this event and writes data into the output buffer 208. While processing audio data, in the event that there is insufficient data in the offload buffer 206, the audio DSP 116 informs the audio driver stack 202 of such insufficiency and the audio driver stack 202 requests the application 212 to provide additional audio data to be placed into the offload buffer 206.

One issue with the configuration of FIG. 2 is that this configuration causes a relatively large amount of activity to occur in system memory 104. Specifically, every time the interconnect controller 118 requires more data from the audio DSP 116, the interconnect controller 118 writes an entry into the event buffer 210 which is in system memory 104. Then, the audio DSP 116 writes the requested audio data into the output buffer 208 which, again, is in system memory 104. Because these requests occur quite frequency—and much more frequently than the application 212 writes data into the offload buffer 206—the memory 104 is quite active while audio is being played.

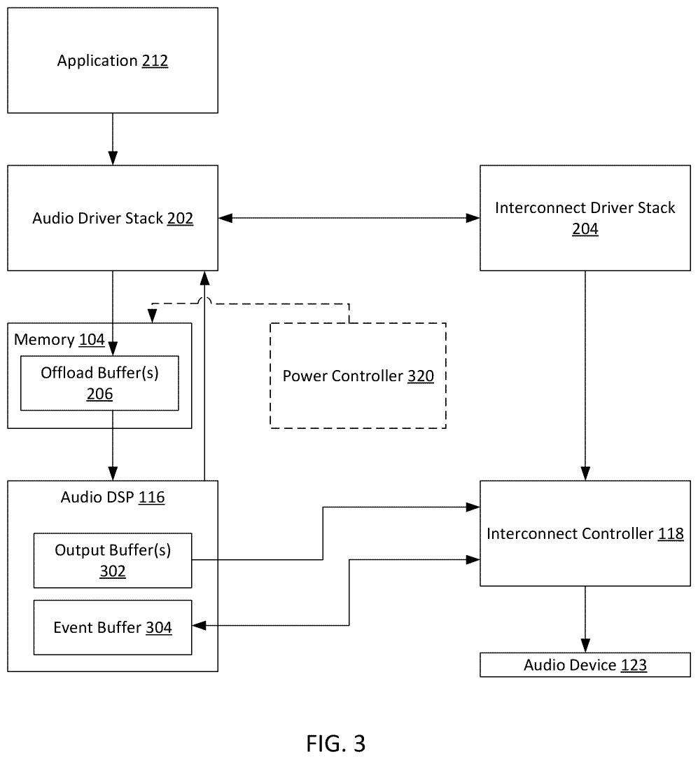

For this reason, a different configuration is provided in FIG. 3. Specifically, in FIG. 3, the audio DSP 116 has access to an output buffer 302 and an event buffer 304, both of which are not part of the system memory 104. In some examples, the audio DSP 116 itself includes the output buffer 302 and event buffer 304, while in other examples, these buffers are not part of the audio DSP 116 but are also not part of the system memory 104. In addition, the interconnect controller 118 is able to directly interface with the audio DSP 116 to obtain audio data for output to the audio device 123.

To initialize this activity, the audio driver stack 202 initializes the offload buffer 206 in the memory 104. The audio DSP 116 also initializes the output buffer 302 and event buffer 304 in the audio DSP 116. The audio driver stack 202 provides addressing parameters to access the output buffer 302 and event buffer 304 to the interconnect driver stack 204, which provides such details to the interconnect controller 118. In various examples, such information includes an address (e.g., a virtual address) of the output buffer 302 and event buffer 304. The interconnect controller 118 is thus able to access the output buffer 302 and event buffer 304 using this addresses (e.g., using an input/output memory management unit to translate such virtual addresses to the physical addresses mapped to the output buffer 302 and event buffer 304).

In operation, the application 212 notifies the audio driver stack 202 that the application 212 desires to provide audio data as output to the audio device 123. In response to this notification, the audio driver stack 202 allocates the offload buffer 206 in system memory 104 and also allocates the output buffer 302 and event buffer 304 of the audio DSP 116. The audio driver stack 202 provides the address of the output buffer 302 and event buffer 304 to the interconnect driver stack 204.

The application writes audio data into the offload buffer 206 and the audio DSP 116 reads that audio data to be processed. The audio DSP 116 processes such audio data and places the results into the output buffer 302. The interconnect controller 118 continuously reads data from the output buffer 302 and provides that data to the audio device 123. The event buffer 304 is a mechanism for communication between the audio DSP 116 and the interconnect controller 118. In some examples, when the interconnect controller 118 requires more audio data to provide to the audio device 123 (e.g., when an internal buffer of the interconnect controller 118 is low), the interconnect controller 118 reads data from the output buffer 302 to provide to the audio device 123. In some examples, the interconnect controller 118 writes an event into the event buffer 304 that the output buffer 302 is low (the amount of new audio data for being sent to the audio device 123 is below a threshold) and in response, the audio DSP 116 processes more data and sends that data to the output buffer 302. In some examples, the audio DSP 116 reads audio data from the offload buffer 206 to perform such processing. In some examples, when the amount of data in the offload buffer 206 is low (e.g., below a threshold), the audio DSP 116 informs the audio driver stack 202 of this deficiency, and the audio driver stack 202 informs the application 212, which writes additional audio data into the offload buffer 206 via the audio driver stack. In some examples, the event buffer 304 provides the capability to discern how much data is consumed from the output buffer 302. In some examples, the output buffer 302 is a ring buffer that is divided into multiple segments. In such examples, the interconnect controller consumes data from the output buffer 302 segment by segment. After each segment consumption, the interconnect controller 118 writes a message in the event buffer 304 that a segment was consumed. The audio DSP 116 examines the event buffer 304 to determine which segments were consumed and thus need new data.

In some examples, communication between the audio DSP 116 and the interconnect controller 118 occurs much more frequently than communication between the application 212 and the audio DSP 116. In an example, the amount of data transferred by the application to the audio DSP 116 is significantly less than the amount of data transferred by the audio DSP 116 to the interconnect controller 118. This allows the memory to be powered down (e.g., by a power controller 320) to a lower power state (e.g., lower than when the memory 104 is being read from, written to, or otherwise accessed) during transfer of data processed by the audio DSP 116 to the interconnect controller 118 than when the application 212 is writing data to the offload buffer 206 or the audio DSP 116 is read data from the offload buffer 206. In various examples, the power controller 320 is hardware (e.g., digital circuitry) configured to perform operations for controlling the power states (e.g., power consumption) of elements of the device, such as the memory 104. In some examples, the power controller 320 is informed or detects that the memory 104 is not being used and, in response, powers the memory 104 down to a lower power state. In the configuration of FIG. 3, the power controller 320 controls the power state of the memory 104.

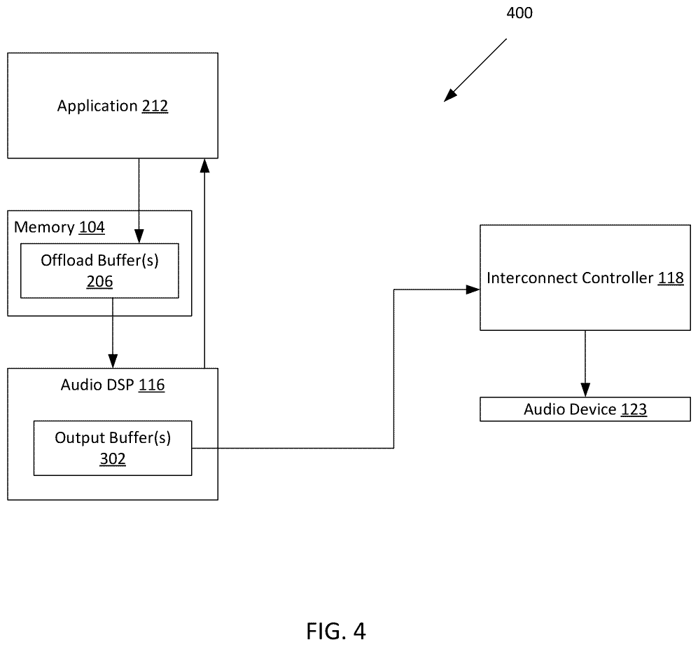

FIG. 4 is a block diagram of a system 400 according to another example. The system 400 includes an application 212, memory 104, audio DSP 116, interconnect controller 118, and audio device. In this example, the application 212 provides audio data to the audio DSP 116 by storing the audio data into the offload buffer 206 of system memory 104. The audio DSP 116 retrieves the audio data, processes the audio data, and stores the audio data into an output buffer 302 of the audio DSP 116, where the output buffer is not in system memory 104.

The interconnect controller 118 receives the processed audio data and provides that audio data to the audio device 123 for playback. The interconnect controller 118 and/or audio DSP 116 monitor the level of the output buffer 302. In the event that the output buffer 302 is low (below a threshold), the audio DSP 116 processes more audio data and provides more audio data into the output buffer 302. In the event that the amount of data in the offload buffer 206 is low (below a threshold), the audio DSP 116 provides a notification of such a level being low to the application 212 and the application 212 is then free to (and in some examples, does) provide additional data to the audio DSP 116.

FIG. 5 is a block diagram of an example audio DSP 500 that is an example implementation of the audio DSP 116, according to an example. The audio DSP 500 includes a set of audio effects pipelines 502, a mixer 504, a global effects pipeline 506, an output buffer 302, and an event buffer 304. Each of these elements is implemented as hardware circuitry and/or instructions executing on a hardware processor.

Each audio effects pipeline 502 receives audio data from the offload buffer 206 which is, in some examples, provided by the application 212. The audio effects pipeline 502 processes this audio data, applying certain effects such as resampling, equalizers, filters, or other effects. A mixer 504 combines the signals, adjusting the resulting amplitude. A global effects pipeline 506 applies global effects such as speaker protection, dynamic range compression, or any other effects that are applied on mixed streams but not on individual streams. Finally, an output buffer 302 receives the output of the global effects pipeline 506 and is ready to be output to the interconnect controller 118 and the audio device 123.

FIG. 6 is a flow diagram of a method 600 for outputting audio, according to an example. Although described with respect to the system of FIGS. 1-5, those of skill in the art will understand that any system configured to perform the method 600 in any technically feasible order falls within the scope of the present disclosure.

In some examples, as part of or prior to the method 600, an application 212 or other entity requests that an audio driver stack 202 initialize an audio offload mechanism. In response, the audio driver stack 202 allocates an offload buffer 206 in memory 104. The audio driver stack 202 also allocates the output buffer 302 and the event buffer 304 in memory of the audio DSP 116. The audio driver stack 202 provides the addresses of the output buffer 302 and the event buffer 304 to the interconnect driver stack 204, which provides that information to the interconnect controller 118 for use for audio playback. In some examples, additional initialization operations include handshake operations between an audio driver, BIOS (“basic input/output system”) components, and the interconnect driver before the buffers are exchanged to determine whether the capability described herein is available in hardware and software.

At step 602, the application 212 or another entity provides audio data to the audio DSP 116. In various examples, the application writes such audio data to an address of an offload buffer 206 in system memory that is accessible to the audio DSP 116. In some examples, this writing is performed using an API, via the audio driver stack 202. For example, the application 212 performs one or more API function calls that includes a pointer to audio data of the application and the audio driver stack 202 and the audio driver stack 202 performs such function by writing the audio data into the offload buffer 206.

At step 604, the audio DSP 116 processes the audio data of the offload buffer 206. In various examples, the audio DSP processing includes one or more of resampling (e.g., changing the sampling rate from that of the audio data provided by the application 212 to a sampling rate set for the audio device 123 (e.g., according to system settings), equalizer effects, filter effects, mixer, channel converter effects, volume and mute control effects, noise reduction, or echo cancellation. In some examples, the same path can be used in reverse for recording. In some examples, the audio DSP 116 receives data from multiple offload buffers 206, each set up by a different application 212, and mixes the results of processing on each such set of data. In some examples, the DSP 116 applies a set of global effects to the mixed audio data, where the set of global effects includes any of a variety of audio effects such as filtering, equalization, volume adjustment, or other effects.

At step 606, the audio DSP 116 writes the output of its processing to an output buffer 302. In some examples, the audio DSP 116 writes the output from the global effects to the output buffer 302 which is external to the system memory 104 (e.g., within the audio DSP 116). More specifically, in some examples, the output buffer 302 is part of the audio DSP 116, requires use of an IOMMU (“input/output memory management unit”) to access, and/or is external to the memory 104 and thus allows the memory 104 to power down even when the output buffer 302 is being accessed by the interconnect controller 118.

At step 608, the interconnect controller 118 receives audio data from the output buffer 302 and provides that audio data to the audio device 123 for output. In some examples, the interconnect controller 118 periodically requests additional data from the output buffer 302. In some examples, this operation occurs as a result of the audio driver stack 202 providing the address of the output buffer 302 to the interconnect controller 118 via the interconnect driver stack 204. Thus, the interconnect controller 118 is capable of accessing the output buffer 302 using this address. In some examples, this access is through an IOMMU, which translates the address, which is virtual, into a physical address of the output buffer 302. In some examples, the event buffer 304 is also utilized to communicate status between the audio DSP 116 and the interconnect controller 118. In some examples, the interconnect controller 18 informs the audio DSP 116 of a need for additional audio data via the event buffer 304 and/or the audio DSP 116 informs the interconnect controller 118 that the output buffer 302 has additional data via the event buffer 304.

In some examples, the audio DSP 116 requests more audio data from the application 212 (e.g., to be placed into the offload buffer 206) via the audio driver stack 202 when the amount of data in the offload buffer 206 is low (e.g., below a threshold). In some examples, while the memory 104 is not being used, and the interconnect controller 118 is reading data from the output buffer 302 of the audio DSP 116, a power controller 320 powers down the memory 104. In some examples, this power down completely de-powers the memory 104, clock-gates the memory, or reduces the capabilities (e.g., clock speed and/or voltage) of the memory 104 such that the memory 104 would be either unable to respond to a request for data from the interconnect controller 118 while in such a low power state, or the bandwidth and/or latency metrics of the memory 104 would be insufficient to provide sufficient data to the interconnect controller if the output buffer 302 were stored in the memory 104.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, interconnect 112, the audio DSP 116, the interconnect controller 118, the audio device 123, the power controller 320, the audio effects pipelines 502, the mixer 504, and the global effects pipeline 506, are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
receiving audio data at an offload buffer in system memory;
processing the audio data by an audio digital signal processor to generate output data and storing the output data in an output buffer of the audio digital signal processor;
transmitting the output data to an interconnect controller from the output buffer; and
outputting the output data from the interconnect controller to an audio device.

2. The method of claim 1 wherein the offload buffer is in system memory and the output buffer is not in system memory.

3. The method of claim 1, wherein the audio data is received at the offload buffer from an application.

4. The method of claim 1, further comprising powering down the system memory while transmitting the output data to the interconnect controller.

5. The method of claim 1, further comprising initializing the offload buffer in system memory by an audio driver stack.

6. The method of claim 1, further comprising initializing the output buffer of the audio digital signal processor, by an audio driver stack, and providing an address of the output buffer to an interconnect driver stack from the audio driver stack.

7. The method of claim 1, wherein the transmitting of the output data to the interconnect controller is performed in response to a read request by the interconnect controller.

8. The method of claim 1, further comprising notifying the audio digital signal processor, by the interconnect controller, that a level of the output buffer is below a threshold.

9. The method of claim 1, further comprising notifying an application by the audio digital signal processor, that a level of the offload buffer is low.

10. A system comprising:
a system memory capable of receiving audio data at an offload buffer;
an audio digital signal processor; and
an interconnect controller,
wherein the audio digital signal processor is configured to:
process the audio data to generate output data to store the output data in an output buffer of the audio digital signal processor, and
transmit the output data to the interconnect controller from the output buffer;
and
wherein the interconnect controller is configured to output the output data to an audio device.

11. The system of claim 10, wherein the offload buffer is in the system memory and the output buffer is not in the system memory.

12. The system of claim 10, wherein the audio data is received at the offload buffer from an application.

13. The system of claim 10, wherein the memory is further configured to power down while the output data is being transmitted to the interconnect controller.

14. The system of claim 10, wherein an audio driver stack is configured to initialize the offload buffer in system memory by an audio driver stack.

15. The system of claim 10, wherein an audio driver stack is configured to initialize the output buffer of the audio digital signal processor and provide an address of the output buffer to an interconnect driver stack.

16. The system of claim 10, wherein the transmitting of the output data to the interconnect controller is performed in response to a read request by the interconnect controller.

17. The system of claim 10, wherein the interconnect controller is further configured to notify the audio digital signal processor that a level of the output buffer is below a threshold.

18. The system of claim 10, wherein the audio digital signal processor is further configured to notify an application that a level of the offload buffer is low.

19. A system comprising:
an audio device;
a system memory capable of receiving audio data at an offload buffer;
an audio digital signal processor; and
an interconnect controller,
wherein the audio digital signal processor is configured to:
process the audio data to generate output data to store the output data in an output buffer of the audio digital signal processor, and
transmit the output data to the interconnect controller from the output buffer;
and
wherein the interconnect controller is configured to output the output data to the audio device.

20. The system of claim 19, wherein the offload buffer is in the system memory and the output buffer is not in the system memory.
